(19) United States
(12) Patent Application Publication
(10) Pub. No.: US 2004/0114058 A1
(43) Pub. Date: Jun. 17, 2004

(54) Projection television

(75) Inventor: Seon-Woo Lim, Suwon city (KR)

Correspondence Address: STAAS & HALSEY LLP, SUITE 700, 1201 NEW YORK AVENUE, N.W., WASHINGTON, DC, 20005, US

(73) Assignee: Samsung Electronics CO., LTD., Suwon city (KR)

(21) Appl. No.: 10/702,503

(22) Filed: Nov. 7, 2003

(30) Foreign Application Priority Data
Dec. 16, 2002 (KR) 2002-80341

(51) Int. Cl. H04N 5/64

(52) U.S. Cl. 348/787; 348/789

(57) ABSTRACT

A projection television including a CRT assembly projecting image beams, and a lower casing accommodating the CRT assembly therein. The projection television further includes a pair of grip parts inwardly recessed on opposite sides of the lower casing so that the CRT assembly is supported by the pair of grip parts. With this configuration, the projection television has a reduced weight with a simple structure, thereby facilitating transportation thereof and decreasing the cost of production and custody therefor. Further, the lower casing provided with the grip part is made of the conductive metallic material, thereby preventing deformation or deterioration due to changes in temperature and humidity, effectively discharging out heat generated from a CRT assembly, and effectively blocking EMI. Further, there is provided a reinforcing member made of the conductive metallic material, thereby effectively discharging out heat generated from a CRT assembly and effectively blocking EMI.

### CROSS-REFERENCE TO RELATED APPLICATIONS

This application claims the benefit of Korean Patent Application No. 2002-80341, filed Dec. 16, 2002, in the Korean Intellectual Property Office, the disclosure of which is incorporated herein by reference.

### BACKGROUND OF THE INVENTION

1. Field of the Invention

The present invention relates to a projection television comprising a CRT (Cathode-Ray Tube) assembly projecting image beams, and a lower casing accommodating the CRT assembly.

2. Description of the Related Art

Generally, a projection television includes a CRT assembly projecting image beams, a reflecting mirror reflecting the projected beams, and a screen displaying thereon pictures based on the reflected beams.

Since this type of projection television is commonly equipped with a large-sized screen, it is voluminous and expensive.

As shown in FIGS. 1 and 2, a conventional projection television comprises front and rear casings 110 and 120 forming an external appearance, a wooden support casing 130 provided between the front casing 110 and the rear casing 120, a CRT assembly 140 coupled with the support casing 130 and projecting image beams, a reflecting mirror 121 reflecting the projected image beams, a screen 112 displaying pictures thereon based on the beams reflected by the reflecting mirror 121, a plurality of speakers (not shown) provided in the lower part of the front casing 110, and a circuit board 160 provided in the lower part of the support casing 130 and controlling the CRT assembly 140.

In the conventional projection television with this configuration, the image beams projected from the CRT assembly 140 are reflected by the reflecting mirror 121 and then directed to the screen 112, thereby forming pictures on the screen 112.

However, in this conventional projection television, since the support casing 130 supporting the CRT assembly 140 and partially forming the external appearance is made of wood sensitive to temperature and humidity, the support casing 130 is likely to be deformed or deteriorated because of changes in temperature and humidity, thereby decreasing the endurance of the projection television.

Further, in the conventional projection television, since the support casing 130 is manufactured with a heavy compressed wood to enhance the intensity thereof, the projection television becomes heavy, thereby causing difficulty in transporting it.

Still further, in the conventional projection television, since the support casing 130 is manually assembled by means of screws, adhesives, etc., the projection television becomes complicated in structure, thereby increasing the production cost. Further, since the support casing 130 is usually delivered in the condition of being assembled by a lumber dealer or maker, etc., it needs a large space for storage and transportation, thereby increasing the cost thereof.

### SUMMARY OF THE INVENTION

Accordingly, it is an aspect of the present invention to provide a projection television whose weight is reduced with a simple structure, thereby decreasing the cost of production and custody therefor.

It is another aspect of the present invention to provide a projection television, in which a wooden part is replaced with a molding part, thereby preventing deformation or deterioration because of changes in temperature and humidity.

Additional aspects and advantages of the invention will be set forth in part in the description which follows and, in part, will be obvious from the description, or may be learned by practice of the invention.

The foregoing and/or other aspects of the present invention are achieved by providing a projection television having a CRT assembly projecting image beams, and a lower casing accommodating the CRT assembly therein, comprising a pair of grip parts inwardly recessed on opposite sides of the lower casing such that the CRT assembly is supported by the pair of grip parts.

According to an aspect of the invention, the grip part includes at least one rib to be connected with the CRT assembly, and a frame bracket formed with a slot to be connected with the rib of the grip part is provided in the CRT assembly.

According to another aspect of the invention, the frame bracket of the CRT assembly is slantingly disposed in correspondence with a projecting angle of the image beams from the CRT assembly.

According to yet another aspect of the invention, the projection television further comprises a reinforcing member provided under each grip part and supporting each grip part.

According to yet another aspect of the invention, an upper part of the reinforcing member is connected to the grip part, being in contact with the CRT assembly.

According to yet another aspect of the invention, the reinforcing member is made of a conductive material to block EMI.

According to still another aspect of the invention, the lower casing is made of a conductive material to block the EMI.

According to still another aspect of the invention, the lower casing is made of a plastic material.

Additional aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the preferred embodiments, taken in conjunction with the accompanying drawings of which:

FIG. 1 is a perspective view of a conventional projection television;

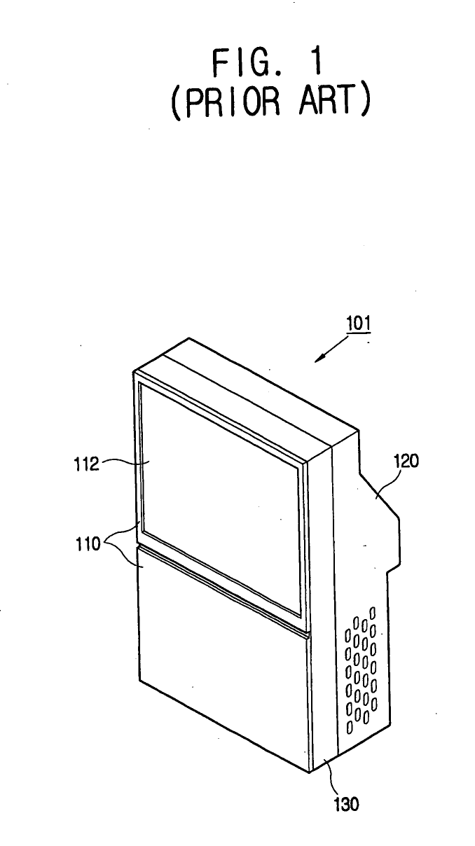

FIG. 2 is an exploded perspective view of the projection television shown in FIG. 1;

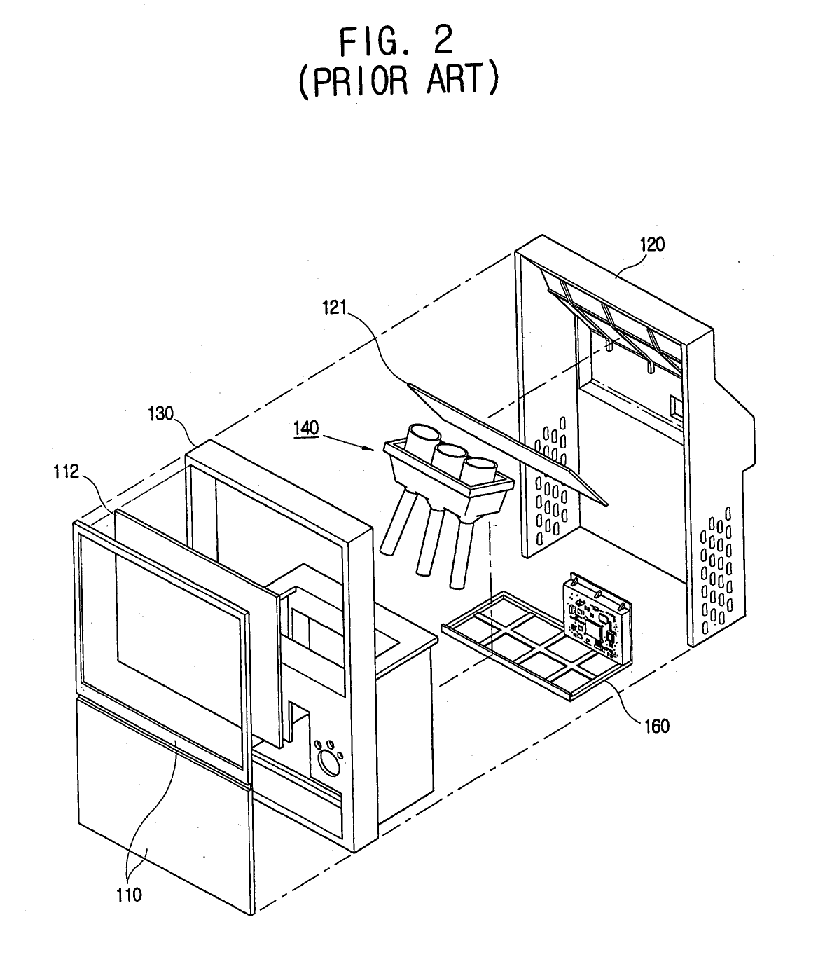

FIG. 3 is a perspective view of a projection television according to the present invention;

FIG. 4 is an exploded perspective view of the projection television shown in FIG. 3; and

FIG. 5 is a partially combined perspective view of the projection television shown in FIG. 3.

### DETAILED DESCRIPTION OF THE PREFERRED EMBODIMENT

Reference will now made in detail to the present preferred embodiments of the present invention, examples of which are illustrated in the accompanying drawings, wherein like reference numerals refer to the like elements throughout. The embodiments are described below in order to explain the present invention by referring to the figures.

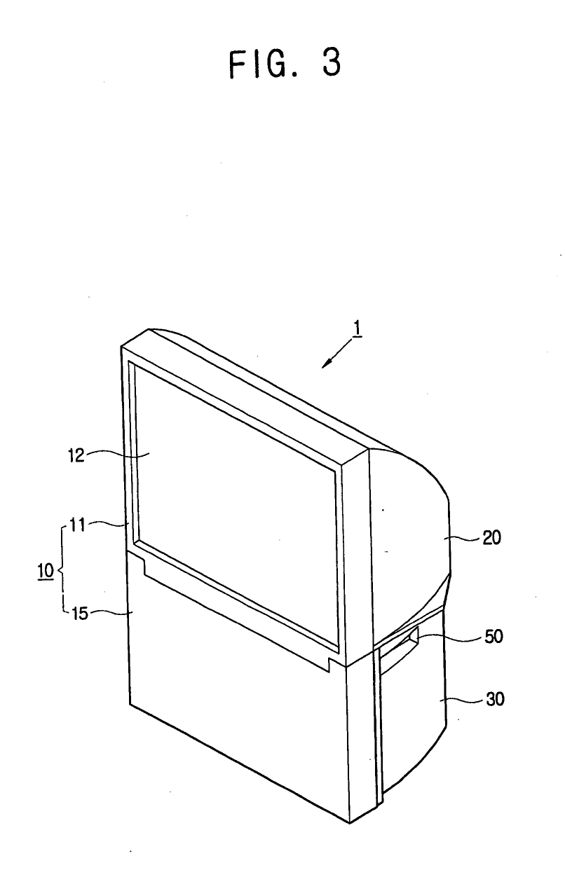

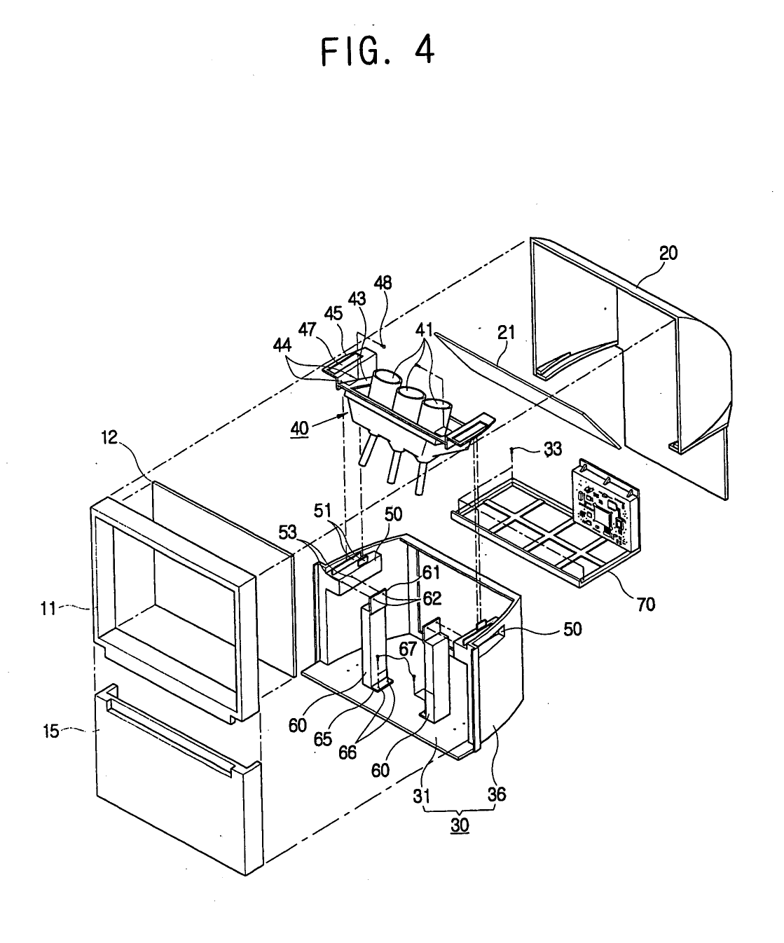

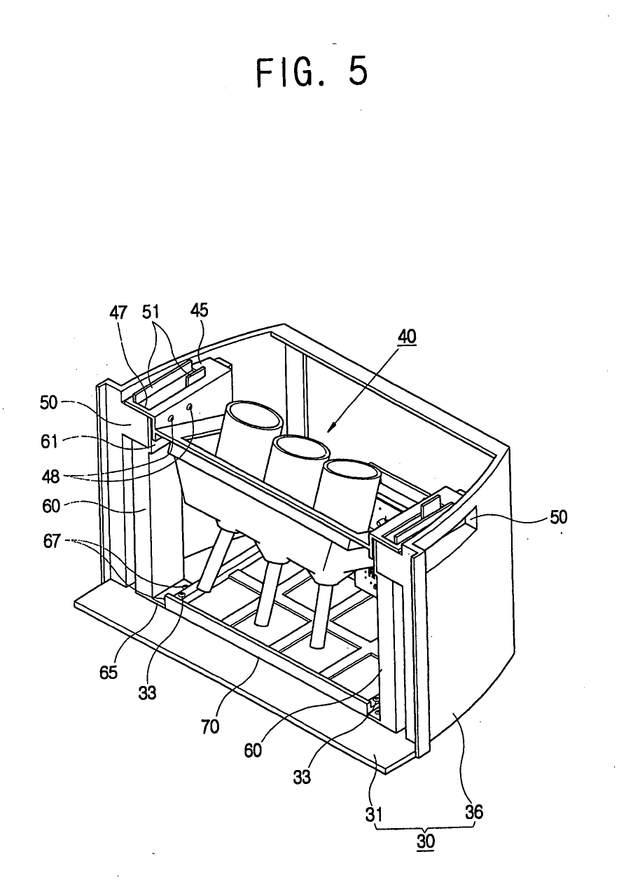

As shown in FIGS. 3 through 5, a projection television 1 according to the present invention comprises front and rear casings 10 and 20 forming an external appearance, a lower casing 30 provided between the front casing 10 and the rear casing 20, a CRT assembly 40 accommodated in the lower casing 30 and projecting image beams, a pair of grip parts 50 each recessed in opposite sides of the lower casing 30 and supporting the CRT assembly 40, reinforcing members 60 respectively provided under the grip parts 50 and supporting the grip part 50, a reflecting mirror 21 reflecting the image beams projected from the CRT assembly 40, a screen 12 displaying thereon pictures based on the image beams reflected by the reflecting mirror 21, a circuit board 70 provided in the lower part of the lower casing 30 and controlling the CRT assembly 40, and a plurality of speakers (not shown) provided in the lower part of the front casing 10.

The front casing 10 includes an upper cover 11 provided on the front top of the projection television 1 and coupled to the front edge of the screen 12 displaying pictures thereon so as to support the screen 12, and a lower cover 15 coupled to the lower part of the upper cover 11 and mounted with the speakers.

On the inside top of the rear casing 20 is provided a reflecting mirror 21 slantingly installed so as to reflect the image beams projected from the CRT assembly 40 toward the screen 12. The front top and the bottom of the rear casing 20 are coupled to the upper cover 11 of the front casing 10 and the lower casing 30 by screws or the like, respectively.

The lower casing 30 includes a bottom part 31 and side parts 36 coupled to the lower opposite sides of the bottom part 31.

On the bottom part 31 is connected the circuit board 70 controlling the CRT assembly 40 by first screws 33.

On the side part 36 is formed the grip part 50 inwardly recessed so as to facilitate carrying the projection television 1.

Further, the lower casing 30 is preferably made of plastic molding which can be inexpensively produced in commercial quantity. However, the lower casing 30 may be made of a conductive metallic material so as to block EMI (Electromagnetic Interference) from the CRT assembly 40 and the circuit board 70 and to easily discharge heat generated from the CRT assembly 40.

The CRT assembly 40 includes a plurality of CRTs 41 projecting image beams, a CRT frame 43 supporting the plurality of CRTs 41, and frame brackets 45 formed on opposite sides of the CRT frame 43 and slantingly disposed to correspond with a projecting angle of the image beams from the CRTs 41.

The CRT frame 43 is made of metal and supports the plurality of CRTs 41. The opposite sides of the CRT frame 43 are formed with a plurality of frame connecting holes 44 into which second screws 48 are inserted so as to connect the CRT frame 43 with an inner part of the grip part 50.

The frame brackets 45 are made of metal and are respectively coupled to the opposite ends of the CRT frame 43. Each frame bracket 45 is formed with a slot 47 through which a rib 51 (to be described later) of the grip part 50 is inserted.

The grip part 50 is inwardly recessed on the side part 36 of the lower casing 30, having a “C”-shaped cross section, and supports the CRT assembly 40. The grip part 50 includes the pair of ribs 51 protruding from the upper surface thereof to be inserted in the slot 47 of the frame bracket 45, and a plurality of grip connecting holes 53 formed on the the inner part thereof to correspond with the plurality of frame connecting holes 44 of the CRT frame 43.

Each reinforcing member 60 is an elongated bar, having a “connecting holes 53 of the grip part 50, and a lower bracket 65 formed with a plurality of lower connecting holes 66 to be connected with the bottom part 31 of the lower casing 30 by third screws 67.

The upper bracket 61 is formed with a plurality of upper connecting holes 62 through which the second screws 48 passes, corresponding to the frame connecting holes 44 of the CRT frame 43 and the grip connecting holes 53 of the grip part 50, across the upper bracket 61 of the reinforcing member 60.

The lower bracket 65 is preferably extended so as to be in contact with the circuit board 70 connected to the bottom part 31 of the lower casing 30.

The reinforcing member 60 stably supports the grip part 50 and the CRT assembly 40, and is made of the conductive metallic material, being in contact with the CRT assembly 40, thereby effectively blocking the EMI from the CRT assembly 40 and discharging heat generated from the plurality of CRTs 41. Further, the reinforcing member 60, made of the conductive metallic material, is connected to the circuit board 70, thereby effectively blocking the EMI from the circuit board 70 as well as the CRT assembly 40. Further, the reinforcing member 60 is manufactured by a pressing or molding method so as to support the grip part 50 and the CRT assembly 40.

As described above, the projection television 1 according to the present invention comprises the pair of grip parts 50 provided in the lower casing 30 and supporting the CRT assembly 40, thereby simplifying the structure of the projection television 1, reducing the weight thereof, facilitating carrying it, and decreasing the cost of custody as compared with the conventional wooden configuration.

Further, in the projection television 1 according to the present invention, the lower casing 30 provided with the grip parts 50 supporting the CRT assembly 40 is made of the conductive metallic material, thereby preventing the influence of temperature and humidity, effectively discharging heat generated from the CRT assembly 40, and effectively blocking the EMI from the CRT assembly 40 and the circuit board 70. Further, the lower casing 30 is made of plastic molding, so that the lower casing 30 resists temperature and humidity and is inexpensively produced in commercial quantity.

Further, the projection television 1 according to the present invention comprises the reinforcing members 60 made of the conductive metallic material and reinforcing and supporting the respective grip parts 50 and the CRT assembly 40, thereby stably supporting the CRT assembly 40, effectively discharging heat generated from the CRT assembly 40, and effectively blocking the EMI from the CRT assembly 40 and the circuit board 70.

As described above, the present invention provides a projection television whose weight is reduced with a simple structure, thereby facilitating transportation thereof and decreasing the cost of production and custody therefor.

Further, the present invention provides a projection television, in which the lower casing provided with the grip parts is made of the conductive metallic material, thereby preventing deformation or deterioration due to changes in temperature and humidity, effectively discharging heat generated from a CRT assembly, and effectively blocking EMI.

Further, the present invention provides a projection television comprising the reinforcing members made of the conductive metallic material, thereby effectively discharging heat generated from a CRT assembly and effectively blocking EMI.

Although a few preferred embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A projection television having a CRT assembly projecting image beams and a lower casing accommodating the CRT assembly therein, comprising:
a pair of grip parts inwardly recessed on opposite sides of the lower casing such that the CRT assembly is supported by the pair of grip parts.

2. The projection television according to claim 1, further comprising:
at least one rib on the grip part connected with the CRT assembly; and
a frame bracket formed with a slot to be connected with the rib of the grip part provided on the CRT assembly.

3. The projection television according to claim 2, wherein the frame bracket of the CRT assembly is slantingly disposed to correspond with a projecting angle of the image beams from the CRT assembly.

4. The projection television according to claim 1, further comprising reinforcing members respectively provided under each grip part and supporting each grip part.

5. The projection television according to claim 4, wherein an upper part of the reinforcing member is connected to the grip part, being in contact with the CRT assembly.

6. The projection television according to claim 5, wherein the reinforcing member is made of a conductive material to block EMI.

7. The projection television according to claim 6, wherein the lower casing is made of a conductive material to block the EMI.

8. The projection television according to claim 6, wherein the lower casing is made of a plastic material.

9. The projection television according to claim 3, further comprising a reinforcing member provided under each grip part and supporting each grip part.

10. The projection television according to claim 9, wherein an upper part of the reinforcing member is connected to the grip part, being in contact with the CRT assembly.

11. The projection television according to claim 10, wherein the reinforcing member is made of a conductive material to block EMI.

12. The projection television according to claim 11, wherein the lower casing is made of a conductive material to block the EMI.

13. The projection television according to claim 11, wherein the lower casing is made of a plastic material.

14. The projection television according to claim 4, wherein the reinforcing members each comprise:
an upper bracket upwardly bent to be in contact with the respective grip part; and
a lower bracket connected to a bottom part of the lower casing.

15. The projection television according to claim 14, wherein the upper brackets are connected to the respective grip part by first screws and lower brackets are connected to the respective lower casing by second screws.

16. The projection television according to claim 15, wherein the upper brackets comprise a plurality of upper connecting holes through which the first screws pass to connect with the grip part.

17. The projection television according to claim 15, wherein the lower brackets comprise a plurality of lower connecting holes through which the second screws pass to connect with the bottom part of the lower casing.

18. A projection television comprising:
a front and rear casing; and
a lower casing provided between the front and rear casings to contain a CRT assembly therein, the lower casing comprising:
a bottom part; and
two side parts coupled to the lower opposite sides of the bottom part, the side parts each having a grip part formed therein to facilitate carrying the television.

19. The projection television according to claim 18, wherein the lower casing is made of a metallic material to block electromagnetic interference (EMI).

20. The projection television according to claim 18, wherein the lower casing further comprises a pair of reinforcing members to support respective grip parts, the reinforcing members being made of a conductive material to block electromagnetic interference (EMI) from the CRT assembly.

21. The projection television according to claim 20, wherein the pair of reinforcing members are formed by pressing or molding with the lower casing to support the respective grip parts.

22. A projection television having a CRT assembly projecting image beams, comprising:
a lower casing accommodating the CRT assembly therein; and
reinforcing members positioned within the lower casing and formed of a conductive material to discharge heat generated from the CRT assembly and block electromagnetic interference.
